(19) United States
(12) Patent Application Publication
(10) Pub. No.: US 2016/0159967 A1
(43) Pub. Date: Jun. 9, 2016

(54) FUNCTIONAL POLYURETHANE FOAM

(71) Applicants: HYUNDAI MOTOR COMPANY, Seoul (KR); KIA MOTORS CORPORATION, Seoul (KR)

(72) Inventors: Jeong-Seok OH, Yongin-shi (KR); Gun KANG, Seoul (KR); Sung-Hyun LEE, Yongin-shi (KR); Hye-Min LEE, Yongin-shi (KR); Soon-Joon JUNG, Seoul (KR); Mi-Jung YUN, Yongin-shi (KR); Kwon-Yong CHOI, Seoul (KR); Gi-Man KIM, Daejeon (KR); Byeong-Guk LIM, Seoul (KR)

(21) Appl. No.: 14/559,904

(22) Filed: Dec. 3, 2014

(51) Int. Cl. C08G 18/76; C08G 18/79

(52) U.S. Cl. CPC C08G 18/7664; C08G 18/7671; C08G 18/797; C08G 2101/00

(57) ABSTRACT

The present disclosure relates to functional polyurethane foams, and in particular, to functional polyurethane foams including a reaction product of a resin premix and an isocyanate component, wherein the resin premix includes a polyol component and a foaming agent, and the isocyanate component includes monomeric methylene diphenyl diisocyanate (MMDI) in 4 to 70% by weight, carbodiimide methylene diphenyl diisocyanate (CMDI) in 5 to 70% by weight and polymeric methylene diphenyl diisocyanate (PMDI) in 10 to 80% by weight, with respect to the total weight of the isocyanate component. The functional polyurethane foams of the present disclosure are capable of being used for vehicle seats and minimizing vibration transmissibility by absorbing a considerable portion of vibrations that occur while driving.

### TECHNICAL FIELD

The present disclosure relates to polyurethane foams, and in particular, to functional polyurethane foams capable of being used for vehicle seats and minimizing vibration transmissibility by absorbing a considerable portion of vibrations that occur while driving.

### BACKGROUND ART

With the development of an automobile industry, the time period inside vehicles increases and currently the importance of riding comfort in vehicles has become significant. Consequently, the level of customer requirements for in-car comfort has become very high.

Polyurethane foam is generally produced from a reaction of a resin premix and isocyanate. The resin premix is a crude liquid in which polyol, a cross-linker, a catalyst, a foaming agent and other additives are mixed, and the isocyanate is a main material in a polyurethane reaction reacting with the resin premix to form a urethane bond.

Such polyurethane foam is known to have various compositions and, as an example, Korean Patent No. 10-0883514 discloses a polyurethane foam composition having superior durability and hydrolysis resistance. However, existing polyurethane foam generally does not have highly superior vibration absorptivity. Therefore, when this polyurethane foam is used for vehicle seats and a driver drives for a long period of time, there has been a problem in that vehicle vibrations are continuously transferred causing inconveniences even though the influence is insignificant in short time driving.

### DISCLOSURE

### Technical Problem

An object of the present disclosure in view of the above is to provide functional polyurethane foam of which vibration absorptivity is improved by using modified methylene diphenyl diisocyanate (MDI) and polyols having molecular weights of approximately 3000 to 7000 without using toluene diisocyanate (TDI).

### Technical Solution

The present disclosure provides a functional polyurethane foam including a reaction product of a resin premix and an isocyanate component, wherein the resin premix includes a polyol component and a foaming agent, and the isocyanate component includes monomeric methylene diphenyl diisocyanate (MMDI) in 4 to 70% by weight, carbodiimide methylene diphenyl diisocyanate (CMDI) in 5 to 70% by weight and polymeric methylene diphenyl diisocyanate (PMDI) in 10 to 80% by weight, with respect to the total weight of the isocyanate component.

Herein, the polyol component preferably has an OH—V of 10 to 60 mg KOH/g, and is more preferably one or more polyol components having an OH—V selected from the group consisting of 20 to 40 mg KOH/g, 20 to 50 mg KOH/g, 20 to 60 mg KOH/g and 10 to 30 mg KOH/g, and the polyol component may include a polyol having an OH—V of 20 to 40 mg KOH/g in 40 to 75% by weight; a polyol having an OH—V of 20 to 50 mg KOH/g in 10 to 40% by weight; and a polyol having an OH—V of 10 to 30 mg KOH/g in 3 to 40% by weight, with respect to the total weight of the polyol component.

Meanwhile, the resin premix may further include a curing catalyst, a foaming catalyst, a cross-linker, a chain extender and a surfactant.

Herein, with respect to 100 parts by weight of the polyol component, the isocyanate component is preferably included in 40 to 70 parts by weight, the curing catalyst in 0.1 to 3 parts by weight, the foaming catalyst in 0.1 to 2 parts by weight, the foaming agent in 1 to 5 parts by weight, the cross-linker in 0.1 to 5 parts by weight, the chain extender is preferably included with a chain extender having an OH—V of 1500 to 2500 mg KOH/g in 1 to 10 parts by weight and a chain extender having an OH—V of 500 to 1500 mg KOH/g in 0.1 to 1 parts by weight, and the surfactant is preferably included in 0.1 to 3 parts by weight.

Vehicle seats may be manufactured with commonly known methods using the functional polyurethane foam satisfying such compositions.

### Advantageous Effects

A functional polyurethane foam according to the present disclosure having constitutions described above has an advantage in that it has superior vibration absorptivity compared to existing polyurethane foams.

In addition, when vehicle seats are manufactured using the functional polyurethane foam, comfort can be improved by absorbing a considerable portion of vibrations occurring on the road.

In addition, by not including toluene diisocyanate (TDI) that has been used in existing polyurethane foams and using only methylene diphenyl diisocyanates (MDIs) as a curing agent, stress reduction of seat foam is minimized, and bearing power supporting the body of a driver can be enhanced for a long time.

### BRIEF DESCRIPTION OF THE DRAWINGS

FIG. 1 is a time-stress graph of seat foam manufactured using TDI, and seat foam manufactured using MDI of the present disclosure.

100: Seat Foam Manufactured Using TDI
200: Seat Foam Manufactured Using MDI

### BEST MODE FOR THE DISCLOSURE

Hereinafter, the present disclosure will be described in detail with reference to an attached drawing.

In one aspect, the present disclosure relates to a functional polyurethane foam of which vibration absorptivity is significantly improved.

Polyurethane foam generally used for vehicle seats and the like is a soft foam obtained by reacting an urethane foam composition containing polyol, isocyanate, a catalyst, a cross-linker, a surfactant and a foaming agent. The polyol has a hydroxyl functional group (—OH), and the isocyanate has an isocyanate functional group (—NCO) within the molecule.

The polyol is divided into monol, diol, triol and the like depending on the number of functional groups within the molecule, and the isocyanate is also divided into monoisocyanate, diisocyanate and the like depending on the number of functional groups per molecule.

A urethane bond is typically formed by the bonding of alcohol having an active hydroxyl group and isocyanate having an isocyanate group as shown in the following Chemical Formula 1.

R—NCO+R′—OH->R—NH—COO—R′ Chemical Formula 1.

A polymer having such a urethane bond in large quantities is referred to as a polyurethane, and such a polyurethane foam is widely used as vehicle components and materials due to superior properties such as low density, high mechanical strength, high thermal resistance and the like, and particularly, is widely used for vehicle seats due to low density and superior durability.

The present disclosure relates to a polyurethane foam containing a reaction product of a resin premix and an isocyanate component, wherein the resin premix includes a polyol component and a foaming agent, and the isocyanate component includes monomeric methylene diphenyl diisocyanate (MMDI) in 4 to 70% by weight; carbodiimide methylene diphenyl diisocyanate (CMDI) in 5 to 70% by weight; and polymeric methylene diphenyl diisocyanate (PMDI) in 10 to 80% by weight, with respect to the total weight of the isocyanate component. The isocyanate component can be mixed and used in 40 to 70 parts by weight with respect to 100 parts by weight of the polyol component.

Hereinafter, the polyurethane foam of the present disclosure is examined in detail with reference to the following Table 1.

TABLE 1

| Constituent | Composition | Note |
|---|---|---|
| First Polyol | 40.0 to 75.0% | Glycerol, OH-V = |
| | by weight | 20 to 40 mg KOH/g |
| Second Polyol | 10.0 to 40.0% | Glycerol, OH-V = |
| | by weight | 20 to 50 mg KOH/g |
| Third Polyol | 5.0 to 30.0% | Glycerol, OH-V = |
| | by weight | 20 to 60 mg KOH/g |
| Fourth Polyol | 3.0 to 40.0% | Glycerol, OH-V = |
| | by weight | 10 to 30 mg KOH/g, |
| | | Solid 30 to 50% |
| First Chain | 1.0 to 10.0 | Diethanolamine, OH-V = |
| Extender | parts by weight | 1500 to 2500 mg KOH/g |
| Second Chain | 0.1 to 1.0 | 1,4-Butanediol, OH-V = |
| Extender | parts by weight | 500 to 1500 mg KOH/g |
| Cross-linker | 0.1 to 5.0 | Triethanolamine, OH-V = |
| | parts by weight | 1500 to 2500 mg KOH/g |
| Water (Foaming | 1.0 to 5.0 | OH-V = |
| Agent) | parts by weight | 6000 to 7000 mg KOH/g |
| Curing Catalyst | 0.1 to 3.0 | 33% Triethylenediamine |
| (Dabco 33LV) | parts by weight | 67% Dipropylene Glycol |
| (Air Products, US) | | |
| Foaming Catalyst | 0.1 to 2.0 | 70% |
| (Dabco BL-11) | parts by weight | Bis(2-dimethylaminoethyl) |
| (Air Products, US) | | ether |
| | | 30% Dipropylene Glycol |
| Surfactant | 0.1 to 3.0 | Polyether Modified |
| (Niax L-3002) | parts by weight | Polysiloxane |
| (Momentive, US) | | |
| Total | The parts by | |
| | weight are based | |
| | on 100 parts by | |
| | weight of the | |
| | polyol component. | |

### (1) Polyol Component

In order to prepare a polyurethane foam, the polyol component is used in at least 60% by weight, and rather than using a single polyol, various types of polyol are used depending on the properties of products and the manufacturing conditions. Polyol is produced by chemical bonding of an initiator, propylene oxide (PO) and ethylene oxide (EO).

A triol having 3 hydroxyl groups is produced when an initiator such as glycerol or glycerin, trimethylolpropane, triethanolamine, 1,2,6-hexanetriol, phosphoric acid, or triisopropanolamine is used. Herein, an OH—V is determined depending on the capping degree of PO/EO, and this is related to the molecular weight of chemically bonded polyol. The polyol component of the present disclosure preferably has an OH—V of 10 to 60 mg KOH/g.

Preferably, the polyol component according to the present disclosure includes one or more polyol components having an OH—V selected from the group consisting of 20 to 40 mg KOH/g, 20 to 50 mg KOH/g, 20 to 60 mg KOH/g and 10 to 30 mg KOH/g.

In terms of a composition, a polyol having an OH—V of 20 to 40 mg KOH/g (first polyol) is preferably included in 40 to 75% by weight with respect to the total weight of the polyol component. When the first polyol is included in less than 40% by weight, rebound resistance is significantly reduced, and when the first polyol is included in greater than 75% by weight, hardness degradation occurs.

In addition, a polyol having an OH—V of 20 to 50 mg KOH/g (second polyol) is preferably included in 10 to 40% by weight with respect to the total weight of the polyol component. When the second polyol is included in less than 10% by weight, vibration transmissibility increases, and when the second polyol is included in greater than 40% by weight, permanent compression set declines.

Furthermore, a polyol having an OH—V of 20 to 60 mg KOH/g (third polyol) is preferably included in 5 to 30% by weight with respect to the total weight of the polyol component. When the third polyol is included in less than 5% by weight, vibration transmissibility increases, and when the third polyol is included in greater than 30% by weight, elasticity and permanent compression set decline.

In addition, a polyol having an OH—V of 10 to 30 mg KOH/g (fourth polyol) is preferably included in 3 to 40% by weight. When the fourth polyol is included in less than 3% by weight, hardness is too low, and when the fourth polyol is included in greater than 40% by weight, hardness is high and the level of comfort declines.

### (2) Isocyanate Component

Isocyanates generally used in the preparation of polyurethane foam include methylene diphenyl diisocyanate (MDI), toluene diisocyanate (TDI) or a combination thereof. The isocyanate component according to the present disclosure preferably includes, without using toluene diisocyanate, monomeric methylene diphenyl diisocyanate (MMDI) in 4 to 70% by weight; carbodiimide methylene diphenyl diisocyanate (CMDI) in 5 to 70% by weight; and polymeric methylene diphenyl diisocyanate (PMDI) in 10 to 80% by weight, with respect to the total weight of the isocyanate component.

Specifically, the monomeric methylene diphenyl diisocyanate and the carbodiimide methylene diphenyl diisocyanate are preferably included in 4 to 70% by weight and 5 to 70% by weight, respectively. When the amount is less than the recommended amount, closed cells are excessively produced leading to the decrease of productivity, and when the amount is greater than the recommended amount, open cells are excessively produced and no foam is produced, which leads to the increase of defect rates.

The polymeric methylene diphenyl diisocyanate (PMDI) is preferably included in 10 to 80% by weight. When it is included in less than 10% by weight, tensile strength and tearing strength are rapidly reduced, and when included in greater than 80% by weight, hardness is rapidly increased.

In other words, force supporting the body of a driver increases by not including TDI that is generally used for seat foam. This is due to the fact that MDI has a relatively higher molecular structure than TDI and increases the bearing power of the foam thereby preventing the deflection of foam from long time driving.

Meanwhile, the resin premix according to the present disclosure preferably further includes a curing catalyst, a foaming catalyst, a cross-linker, a chain extender and a surfactant.

### (3) Chain Extender and Cross-Linker

The chain extender and the cross-linker are reactive single molecules used for strengthening intermolecular bonding. The chain extender plays a role of extending a main chain, and normally uses secondary alcohols and amines, and the cross-linker plays a role of making the chain into a mesh structure or a branch structure, and normally uses tertiary or higher alcohols and amines.

The chain extender and the cross-linker increase intramolecular cross-linking power and thereby play an important role in improving general physical properties such as tensile and tear, and at the same time, may maintain product properties under high temperature and high humidity conditions by increasing hydrolysis resistance.

However, productivity rather decreases when required properties of only a final product are satisfied due to problems such as closed cells and flowability.

Consequently, with respect to 100 parts by weight of the polyol component, the chain extender having an OH—V of 1500 to 2500 mg KOH/g (first chain extender) is preferably included in 1 to 10 parts by weight and the chain extender having an OH—V of 500 to 1500 mg KOH/g (second chain extender) in 0.1 to 1 parts by weight.

When the first chain extender is included in less than 1 parts by weight, tensile and tear are degraded, and when included in greater than 10 parts by weight, closed cells are excessively produced leading to the rapid decrease of productivity. When the second chain extender is included in less than 0.1 parts by weight, the effects of addition are insignificant, and when included in greater than 1 part by weight, flowability decreases.

In addition, the cross-linker is preferably included in 0.1 to 5 parts by weight. When the cross-linker is included in less than 0.1 parts by weight, the effects of addition are insignificant, and when included in greater than 5 parts by weight, flowability decreases leading to the increase of defect rates.

### (4) Curing Catalyst and Foaming Catalyst

The curing catalyst and the foaming catalyst play a role of lowering the activation energy of a reaction between the isocyanate and the polyol. The production of stable polyurethane foam products may be accomplished depending on the degree of the use of these two catalysts.

While not being limited thereto, representative examples of the curing catalyst may include triethylene diamine, dimethyl piperidine and the like, and representative examples of the foaming catalyst may include triethylamine, N,N′-dimethylcyclohexylamine and the like. In most conditions of production, the time for form removal is present, and in order to finish the production of products within such a limited time range, the curing catalyst is preferably used in a maximum of 3 parts by weight, and the foaming catalyst in a maximum of 2 parts by weight.

In terms of a composition, the curing catalyst is preferably included in 0.1 to 3 parts by weight, and the foaming catalyst included in 0.1 to 2 parts by weight with respect to 100 parts by weight of the polyol component. When the amount is less than the recommended amount, productivity decreases due to the reduction of curability, and when the amount is greater than the recommended amount, pore defects may occur due to the decrease of flowability.

### (5) Foaming Agent

The foaming agent is largely divided into physical foaming agents and chemical foaming agents, and in the case of the present disclosure, using a chemical foaming agent is preferable. A reaction rate, curability and free rise density are determined depending on the amount of the foaming agent used. Therefore, the amount to use is determined depending on the condition of production within the limit of a maximum of 5 parts by weight. Particularly, water is preferably used for a chemical foaming agent used for vehicle seats.

In terms of a composition, the foaming agent is preferably included in 1 to 5 parts by weight with respect to 100 parts by weight of the polyol component. When the foaming agent is included in less than 1 part by weight, the density required for seats is difficult to obtain due to the low foaming ratio, and when included in greater than 5 parts by weight, physical properties are degraded due to excessive foaming.

### (6) Surfactant

Generally, silicon-series surfactants such as polyether-modified polysiloxanes are preferably used as the surfactant. The surfactant participates in an emulsion action helping the reaction of MDI and polyol, forms microbubbles by lowering surface tension, and also plays a role of stabilizing these microbubbles.

In terms of a composition, the surfactant is preferably included in 0.1 to 3 parts by weight with respect to 100 parts by weight of the polyol component. When the surfactant is included in less than 0.1 parts by weight, the urethane foam is not formed, and when included in greater than 3 parts by weight, the productivity decreases due to excess production of closed cells.

Functional polyurethane foams having a composition such as above may be used for vehicle seats and the like using common processes known in the art, and vehicle seats minimizing vibration transmissibility and improving comfort may be manufactured.

Hereinafter, the present disclosure will be described in more detail with reference to examples. However, these examples are for illustrative purposes only, and it will be obvious to those skilled in the art that the scope of the present disclosure is not interpreted to be limited to these examples.

TABLE 2

| | Comparative Examples | | | | Examples | |
|---|---|---|---|---|---|---|
| | 1 | 2 | 3 | 4 | 1 | 2 |
| First Polyol | 80% by | 60% by | 60% by | 60% by | 60% by | 60% by |
| | weight | weight | weight | weight | weight | weight |
| Second Polyol | — | — | 20% by | 20% by | 20% by | 20% by |
| | | | weight | weight | weight | weight |
| Third Polyol | — | 20% by | — | — | — | — |
| | | weight | | | | |
| Fourth Polyol | 20% by | 20% by | 20% by | 20% by | 20% by | 20% by |
| | weight | weight | weight | weight | weight | weight |
| HMDI | 70% by | 70% by | 80% by | 15% by | 20% by | 30% by |
| | weight | weight | weight | weight | weight | weight |
| CMDI | — | — | 15% by | 80% by | 40% by | 30% by |
| | | | weight | weight | weight | weight |
| PMDI | — | — | 5% by | 5% by | 40% by | 40% by |
| | | | weight | weight | weight | weight |
| TDI Derivative | 30% by | 30% by | — | — | — | — |
| | weight | weight | | | | |

In Table 2, the amounts of the first polyol to the fourth polyol represented in % by weight are based on the total weight of the polyol component, and the amounts of the MMDI, the CMDI, the PMDI and the TDI derivative represented in % by weight are based on the total weight of the isocyanate component. The isocyanate component was mixed in 60 parts by weight with respect to 100 parts by weight of the polyol component.

TABLE 3

| | Comparative Examples | | | | Examples | |
|---|---|---|---|---|---|---|
| | 1 | 2 | 3 | 4 | 1 | 2 |
| Hardness | 27 | 30 | 31 | 29 | 27 | 30 |
| (kgf/m³) | | | | | | |
| Hysteresis Loss | 29 | 34 | 26 | 23 | 19 | 21 |
| (%) | | | | | | |
| Tensile Strength | 2.1 | 1.85 | 2.3 | 1.9 | 1.94 | 2.1 |
| (kgf/cm²) | | | | | | |
| Elongation (%) | 120 | 122 | 90 | 105 | 116 | 120 |
| Tearing Strength | 0.94 | 0.72 | 0.85 | 0.65 | 0.72 | 0.79 |
| (kgf/cm²) | | | | | | |
| Permanent Com- | 3.2 | 12.5 | 5.7 | 8.5 | 7.7 | 9.5 |
| pression Set (%) | | | | | | |
| Vibration | 6.5 | 5.7 | 5.5 | 4.5 | 3.2 | 3.9 |
| Transmissivity | | | | | | |
| Stress Relaxation | 25 | 23 | 22 | 22 | 21 | 20 |
| (%) | | | | | | |

Table 3 is a table measuring the mechanical properties of the polyurethane foams prepared in the composition of Table 2.

Vibration transmissivity is a value dividing all vibrations transferred to seats while driving by a vibration felt by a driver, and as the value decreases, dynamic comfort is improved since the seats absorb much vibration. For the vibration transmissivity, vibrations generated on the road while driving a vehicle were artificially generated through a vibration generator and transferred to the urethane foam, and the vibration absorption of the urethane foam was measured.

Stress relaxation means a phenomenon in which stress within an object is reduced by time when instantly given strain is constantly maintained, and as the stress relaxation value becomes smaller, the bearing power of the seat foam supporting the body of a driver may be maintained even when the driver drives for a long period of time.

As shown in the table, vibration transmissivity was low when only MDI was used compared to when the existing TDI derivative was used, and particularly, when the composition satisfied the composition according to the present disclosure, vibration transmissivity exhibited the lowest value of 3.2 to 3.9, and the hysteresis loss values were also generally low.

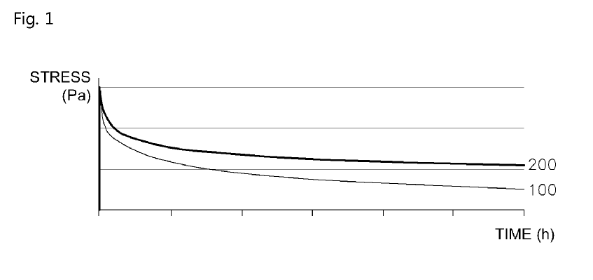

FIG. 1 shows a time-stress graph of seat foam manufactured using TDI, and seat foam manufactured using MDI according to the present disclosure, and as shown by a diagram, it is identified that seat foam manufactured using MDI (200) has higher bearing power supporting the body of a driver than seat foam manufactured using TDI (100) since the seat foam manufactured using MDI has relatively less stress reduction even when the driver drives for a long period of time. This is due to the fact that MDI has relatively higher molecular structure than TDI.

Hereinbefore, the present disclosure has been described with reference to specific embodiments of the present disclosure, however, this is for illustrative purposes only, and the present disclosure is not limited thereto. Those skilled in the art to which the present disclosure pertains may change or modify the described embodiments without departing from the scope of the present disclosure, and various revisions and modifications may be made within technological ideas and equal scopes of the claims of the present disclosure described below.

What is claimed is:

1. A functional polyurethane foam comprising a reaction product of a resin premix and an isocyanate component,
wherein the resin premix includes a polyol component and a foaming agent; and
wherein the isocyanate component includes monomeric methylene diphenyl diisocyanate (MMDI) in 4 to 70% by weight, carbodiimide methylene diphenyl diisocyanate (CMDI) in 5 to 70% by weight and polymeric methylene diphenyl diisocyanate (PMDI) in 10 to 80% by weight, with respect to the total weight of the isocyanate component.

2. The functional polyurethane foam of claim 1, wherein the polyol component has an OH—V of 10 to 60 mg KOH/g.

3. The functional polyurethane foam of claim 2, wherein the polyol component is one or more polyol components having an OH—V selected from the group consisting of 20 to 40 mg KOH/g, 20 to 50 mg KOH/g, 20 to 60 mg KOH/g and 10 to 30 mg KOH/g.

4. The functional polyurethane foam of claim 3, wherein the polyol component includes a polyol having an OH—V of 20 to 40 mg KOH/g in 40 to 75% by weight; a polyol having an OH—V of 20 to 50 mg KOH/g in 10 to 40% by weight; and a polyol having an OH—V of 10 to 30 mg KOH/g in 3 to 40% by weight, with respect to the total weight of the polyol component.

5. The functional polyurethane foam of claim 1, wherein the resin premix further includes a curing catalyst, a foaming catalyst, a cross-linker, a chain extender and a surfactant.

6. The functional polyurethane foam of claim 5, wherein the isocyanate component is included in 40 to 70 parts by weight with respect to 100 parts by weight of the polyol component.

7. The functional polyurethane foam of claim 5, wherein the curing catalyst is included in 0.1 to 3 parts by weight with respect to 100 parts by weight of the polyol component.

8. The functional polyurethane foam of claim 5, wherein the foaming catalyst is included in 0.1 to 2 parts by weight with respect to 100 parts by weight of the polyol component.

9. The functional polyurethane foam of claim 1, wherein the foaming agent is included in 1 to 5 parts by weight with respect to 100 parts by weight of the polyol component.

10. The functional polyurethane foam of claim 5, wherein the cross-linker is included in 0.1 to 5 parts by weight with respect to 100 parts by weight of the polyol component.

11. The functional polyurethane foam of claim 5, wherein, the chain extender is included with a chain extender having an OH—V of 1500 to 2500 mg KOH/g in 1 to 10 parts by weight and a chain extender having an OH—V of 500 to 1500 mg KOH/g in 0.1 to 1 parts by weight, with respect to 100 parts by weight of the polyol component.

12. The functional polyurethane foam of claim 5, wherein the surfactant is included in 0.1 to 3 parts by weight with respect to 100 parts by weight of the polyol component.

13. A vehicle seat including the functional polyurethane foam of claim 1.
